(19) United States
(12) Patent Application Publication
(10) Pub. No.: US 2025/0377955 A1
(43) Pub. Date: Dec. 11, 2025

(54) LIVE ACTIVITIES ON WATCH

(71) Applicant: Apple Inc., Cupertino, CA (US)

(72) Inventors: Morgan J. Grainger, Nashville, TN (US); Forest A. Hill, Lafayette, CO (US); Matthew S. Koonce, San Jose, CA (US); Antony J. Dzeryn, Round Rock, TX (US)

(73) Assignee: Apple Inc., Cupertino, CA (US)

(21) Appl. No.: 19/018,979

(22) Filed: Jan. 13, 2025

Related U.S. Application Data
(60) Provisional application No. 63/657,468, filed on Jun. 7, 2024.

(51) Int. Cl. G06F 9/54

(52) U.S. Cl. CPC G06F 9/54

(57) ABSTRACT

A method of providing an update from an active session to a user. The method comprising performing, by a first device, detecting a first update from a first sequence of updates of a first active session of a first application running on the first device; obtaining, first content based on the first update of the first active session; generating, by the first routine, a first message using the first content, the first message configured to be interpretable by a second routine of a second device and to cause the second device to display the first content; and transmitting, to the second device, the first message; subsequently, detecting a second update from a second sequence of updates of a second active session of a second application running on the first device; and repeating to transmit a second message.

### CROSS-REFERENCES TO OTHER APPLICATIONS

This application claims priority to U.S. Provisional Application No. 63/657,468, for “LIVE ACTIVITIES ON WATCH” filed on Jun. 7, 2024, which is herein incorporated by reference in its entirety for all purposes.

### BACKGROUND

Users may rely on smartphones and other devices that have become ubiquitous for providing updates. Updates on these devices may become crowded and not easily displayed to the user. While certain types of updates may be more prominently displayed within the smartphone (or other device), it is desirable to transmit the updates to other devices in a manner that will be more likely to be viewed by the user.

### BRIEF SUMMARY

Aspects of the disclosed technology may include a system of one or more computers which can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Examples include a method of providing an update from an active session to a user. The method of providing may include detecting a first update from a first sequence of updates of a first active session of a first application running on the first device. The method may include obtaining, by a first routine on the first device, first content based on the first update of the first active session. The method may include generating, by the first routine, a first message using the first content, the first message configured to be interpretable by a second routine of a second device and to cause the second device to display the first content. The method may include transmitting, to the second device, the first message. The method may include subsequently, detecting a second update from a second sequence of updates of a second active session of a second application running on the first device. The method may include obtaining, by the first routine, second content based on the second update of the second active session. The method may include generating, by the first routine, a second message using the second content, the second message configured to be interpretable by the second routine and to cause the second device to display the second content. The method may include transmitting, from the first device to the second device, the second message. Other embodiments of this aspect include corresponding computer systems, apparatus, and computer programs recorded on one or more computer storage devices, each configured to perform the actions of the methods.

In some examples, the method may include displaying, on the first device, the first update from the first sequence of updates and the second update from the second sequence of updates. The first content and the second content may be displayed sequentially on the first device. The method may include detecting, a state of the first device or a state of the second device, and modifying one or more aspects related to the first message or the second message. The method may include, modifying, a frequency of transmission of messages related to the first active session or the second active session based on the state of the first device or the state of the second device. The method may include, modifying, metadata of the first message or metadata of the second message based on the state of the first device or the state of the second device. The method may include, modifying, the first content or the second content based on the state of the first device or the state of the second device. The first application may specify a characteristic, the characteristic modifying a visualization of the first content on the second device. The method may include detecting a third update from the first sequence of updates of a first active session of a first application running on the first device; obtaining, by a first routine on the first device, third content based on the third update of the first active session; generating, by the first routine, a third message using the third content, the third message configured to be interpretable by a second routine of a second device and to cause the second device to display the third content; and transmitting, to the second device, the third message. The method may include detecting a fourth update from a second sequence of updates of a second active session of a second application running on the first device; obtaining, by the first routine, fourth content based on the fourth update of the second active session; generating, by the first routine, a fourth message using the fourth content, the fourth message configured to be interpretable by the second routine and to cause the second device to display the fourth content; and transmitting, from the first device to the second device, the fourth message. The first message, the second message, the third message, and the fourth message are processed sequentially on the second device, where the first message, second message, third message, and fourth message contain a time value indicating how long the message is to be displayed on the second device. The second message is configured to terminate the display of the first message on the second device. Implementations of the described techniques may include hardware, a method or process, or computer software on a computer-accessible medium.

Aspects of the disclosed technology may include a method of providing an update from an active session to a user. The method of providing also includes detecting, by a routine on the accessory device, a first message transmitted from a first device, the first message generated using first content based on a first update of a first active session of a first application running on the first device. The method may include extracting the first content from the first message to extract the first content. The method may include displaying the first content on the accessory device. The method may include detecting, by the routine of the accessory device, a second message transmitted from the first device, the second message generated using second content based on a second update of a second active session of a second application running on the first device. The method may include extracting the second content from the second message to extract the second content. The method may include displaying the second content on the accessory device. Other embodiments of this aspect include corresponding computer systems, apparatus, and computer programs recorded on one or more computer storage devices, each configured to perform the actions of the methods.

The routine on the accessory device may be a system routine of the accessory device. The method may include detecting, by the routine on the accessory device, one or more additional messages transmitted from the first device, the one or more additional messages generated using one or more additional content respectively based on one or more updates of the first active session of the first application running on the first device; and detecting, by the routine on the accessory device, one or more additional messages transmitted from the first device, the one or more additional messages generated using one or more additional content respectively based on one or more updates of the second active session of the second application running on the first device. The first message and the second message may contain priority information, the priority information indicating the priority of the message for display. The first message and the second message may contain metadata indicating how to render the first content and the second content on the accessory device. The first content and the second content contain animations. The method may include, transmitting from the accessory device to the first device, a pause message, the pause message configured to cause the first device to pause a transmission of additional updates from the first active session of a first application to the accessory device. The pause message is generated based on a state of the accessory device. The method may include, transmitting from the accessory device to the first device, a resume message, the resume message configured to cause the first device to resume a transmission of additional updates from the first active session of a first application to the accessory device. A stop message is generated based on a state of the accessory device. The method may include, transmitting from the accessory device to the first device, a stop message configured to cause the first device to terminate a transmission of additional updates from the first active session of a first application. The first content and the second content are displayed within a smart stack of the accessory device. The first content and the second content are configured to receive user input. Implementations of the described techniques may include hardware, a method or process, or computer software on a computer-accessible medium. Aspects of the disclosed technology may include a non-transitory computer readable medium containing instructions that, when executed by one or more processors, cause the one or more processors to perform any of the methods described. Aspects of the disclosed technology include a system comprising one or more processors and non-transitory computer readable medium containing instructions that, when executed by one or more processors, cause the system to perform any of the methods of any of the preceding claims.

### BRIEF DESCRIPTION OF THE DRAWINGS

FIG. 1 shows an example device with live updates according to embodiments of the present disclosure.

FIG. 2 illustrates a block diagram showing communication between a primary device and an auxiliary device according to embodiments of the present disclosure.

FIG. 3 illustrates a method for transmitting live updates to an auxiliary device, according to embodiments of the present disclosure.

FIG. 4 illustrates a method of receiving live updates from a primary device, according to embodiments of the present disclosure.

FIG. 5A-5F illustrates a method related to API architecture, according to embodiments of the present disclosure.

FIG. 6 illustrates a block diagram of an example electronic device, according to at least one embodiment.

### DETAILED DESCRIPTION

Live activities may be a type or class of notifications based on ongoing events or activities within an application, typically generated on a primary device (smartphone). Live activities may be generated by an application operating on a primary device (e.g., a cellular phone). Live activities may include processes or activities for which information may be updated over time and relates to the underlying process or activity. For example, live activities may include updates to scores on a sports match, changes to a gate for departure of a flight, changes to an estimated time during a navigation, changes to a pickup location for a ride share application, etc., As another example, a ride-sharing app might generate a live activity notification when a driver is near, and this live activity can be shown on various parts of a phone, including the phone's lock screen or a portion of the primary device dedicated for the same (e.g., a portion that displays ongoing notifications that are updates to a live activity).

Currently, displaying the live activity on the auxiliary device requires a dedicated application on the auxiliary device, without which the live activity would not be displayed as a live activity on the auxiliary device. Thus, there is a need to provide generalized mechanisms to allow for live activities to be transmitted to an auxiliary device (e.g., smart watches, laptops, etc.). As an example, a live activity may be a sports game, with specific updates taking place when a team scores a point. In the current ecosystem, users face challenges in receiving real-time updates with respect to the live activity if the device does not have the corresponding application installed. An update (e.g., change to a score of an ongoing sports game) may not be obtained and displayed if the device does not have the relevant application.

Requiring the application on the device may lead to increased development efforts by a developer and potentially inconsistent user experiences. Thus, it is desirable to provide live updates on a device without requiring installation of the related application on the device.

As used herein, an auxiliary device (also referred to herein as an accessory device) is a class of a device that may be operated in conjunction with a primary device. For example, an accessory device may comprise a wearable computer device, such as a watch or health signs monitor or similar device of reduced size (e.g., any device that can be worn around a wrist, finger, neck, ear, and the like, or can be otherwise attached to a person or to the person's clothing). Such accessory computing devices have limited resources in that they have processors that are of relatively lesser capability, or have limited storage capacity, as compared with, for example, mobile computing devices such as smart telephones or tablet computers. The limited resources of an accessory computing device can result in challenging conditions for installing applications and providing useful features for a user. An accessory device may be referred to as an auxiliary device.

A live activity may refer to an ongoing activity. A live activity may be an active session of an application. The live activity may have a start point and be ongoing in time until it is complete or terminated. The live activity may have one or more updates, which may be particularly relevant to a user as determined by the application. These updates to the live activity may be displayed in a particular manner. In some examples, an update to a live activity may be referred to as a live update. The live updates may occur at any time during the live activity, and need not be predetermined, as they may be based on a number of conditions.

Aspects of the disclosed technology allow for real-time updates (e.g., updates to ongoing activities, such as updates to live activities) on a device (auxiliary device) by using content received from a primary device (e.g., a phone), where the content is packed in a general manner and the auxiliary device has a routine (e.g., a system routine) that can display such content regardless of the application associated with such content. A custom API may be used to mimic the live activities on the auxiliary device, such as a smartwatch, based on data received from the primary device. A developer can define how the live activity should be displayed on the auxiliary device. The generation of a payload from the primary device can be transmitted to the auxiliary device to allow it to process the content and display it as a live activity, even without a version of the application related to the live activity being installed or instantiated on the auxiliary device.

In various embodiments, systems and methods are provided to allow for a user experience by ensuring that, with respect to live activities, both updates and the view of those updates on the smartwatch are consistent with those on the primary device. The primary device (e.g., mobile device) handles the primary processing and sends a “mirror” of the update to the auxiliary device (e.g., smart watch). This approach avoids the need for developers to separately manage the smartwatch interface, simplifying the development process and ensuring consistency.

The primary device may detect updates related to live activities from an application. These updates may used to generate content, that includes both the data and metadata necessary for displaying the information on the auxiliary device. The content is then packaged into a message (e.g., a payload) that is transmitted to the auxiliary device. This message is configured to be displayed by a routine of the auxiliary device without requiring the application related to the live activity to be installed on the auxiliary device.

As new updates or changes to the live activity are detected on the primary device, new content may be generated and transmitted to the auxiliary device. The primary device (or application thereon) can also determine when and which updates are transmitted to the auxiliary device based on one or more criteria (battery of watch, importance of update, state of watch or cell phone). Content contained within an update may be displayed on the auxiliary device in various manners. The content may also have interactive elements, allowing users to engage with the content, such as swiping away notifications or expanding them for more details. Updates to live activities may be seen directly in the “smart stack” of the auxiliary device.

Additional aspects of the disclosed technology may include optimization of power consumption and integration of the live activity into a “smart stack” of the auxiliary device. The state of the watch can be considered in determining whether to send updates. In some examples, when the live activity ends, the primary device can send a termination message and/or terminational signal to the auxiliary device, prompting it to remove the display. Additional functionality can be provided if the application related to the live activity is present or has been installed on the auxiliary device when the update to the live activity is present.

According to an aspect, the phone filters may filter which live activities (or updates to existing live activities) are sent to the watch, and may determine when to send such live activity notifications. For example, if the life activity relates to a basketball game, and the live activity update is for a statistic that is not shown in the live activity UI on the phone, then the update may similarly not be sent to the accessory device. The primary device can also determine whether to send live activity notifications to conserve resources (e.g., battery life, compute resources, etc.) on the watch. Similarly, if the watch is in a “low activity” mode or has not been active or used for a set period of time, no live updates may be transmitted to the accessory device.

In some examples, a developer or an application can define or can create a template that defines how a live activity UI should appear on the primary device, and a corresponding template for how the UI should appear on the accessory device. In some examples, the primary device template may contain additional data than the watch template. The accessory device may display the update to the live activity in various manners (e.g., in a banner, in a smart stack, etc.) in accordance with a template that has been specified for the accessory.

In some cases, the live activity user interface on the primary device may contain interactive UI elements, such as a button. In some examples, if a corresponding application to the application generating the live activity is loaded on the watch, the clicking the button will execute an action on the watch. In some examples, if the corresponding application is not loaded on the watch, then clicking the UI element (e.g., button) may trigger an action on the phone (e.g., open the app on the primary device, perform an operation on the primary device, etc.). In yet another case, even if the application is loaded on the watch, clicking the button will trigger an action on the primary device (e.g., perform an operation on the phone, etc.).

In some examples, a live activity can be triggered by the accessory (e.g., by an app running on the accessory). Example live activities may be displayed in a “smart stack” which may contain multiple live activities within one display. Data which is displayed in the live activity user interface, such as that shown in the smart stack, may be updated with data generated by the application running on the accessory device, or updated via a communication received from a server that is operating in conjunction with the application. In this manner, bidirectional communication between the primary application and the secondary application can ensure that the live updates are synchronized. For example, if the user launches a ride share app on their watch, the live activity can access updates from either the app or the ride-share server (e.g., via a push notification). Examples may include techniques for managing data coordination between an application which is present on the primary device and present on the second device. For example, if an application is running on the watch, the smart stack updates the live activity UI using data from the application on the watch rather than the application on the phone.

These and additional aspects of the disclosed technology are further discussed below.

### I. Example Primary Device with Live Updates

Prior to a discussion of specific techniques related to providing live updates to an auxiliary device, an example primary device and a discussion of live updates are provided.

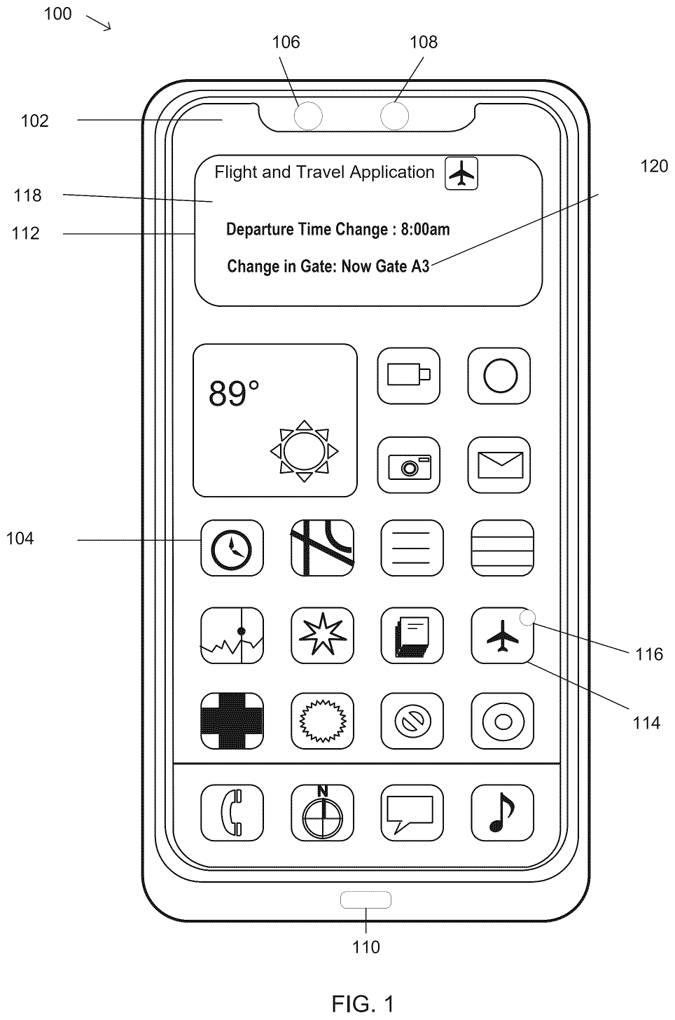

FIG. 1 is a diagram of a mobile device displaying a live update, according to one or more embodiments. The mobile device 100 can be, for example, any suitable computing device such as a laptop or a smartphone. The mobile device 100 can include a display 102 for displaying a message (e.g., a health event message). The display 102 can include touch sensor technology for converting a touch to an electronic signal. The display 102 can be configured to display one or more application icons 104. In some embodiments, the mobile device 100 can include an image-capturing device 106, a microphone 108, and a speaker 110.

The mobile device 100 can be configured to display one or more updates related to a live activity 112 on the display 102. The live activity display 112 can be displayed on a portion of the display 102, and be a system process of an application executing on the user device 100. The live activity display 112 can further be larger than the one or more application icons 104. One or more updates to the live activity display 112 can be configured to be displayed on a portion of the display 102. In some examples, the updates to the live activity display 112 can vary in size over time.

One or more updates to a live activity, such as one or more update messages, may be displayed on the live activity display 112. These updates may be obtained from an application and be configured to display on the live activity display 112. For example, an application can generate computer-readable instructions that can be transmitted to a system process of the device 100 to be displayed on the live activity display 112. The application can be displayed on the live activity display rather than through another form of indication, such as for example, an SMS message, email message, or other message type. The user who may be using the device 100 may thus experience the update to the live activity within the live activity display 112, that may be prominent on the live activity display 112 of the device 100, and may prevent the message from being lost amongst other message types. As seen in FIG. 1, if a notification related to the live activity (e.g., a change in the gate to a departing flight) was also transmitted via an application (e.g., such as in a banner), the application icon 114 may include or have a visual push notification 216 (e.g., a number or other indication that a notification is pending) that a notification is available to view, but that notification may have been hidden within the application. A user may still be able to access the information that was transmitted through this mechanism, but may still have to access the message through the application, and possibly sift through multiple screens or layers before seeing the information related to the notification.

The live activity display 112 can display one or more messages. The live activity display 112 can further provide a prompt to access a recording of a person wanting assistance. As illustrated, the live activity display 112 is displaying an update 118 for a change in a gate. The update 118 can include a location of the change in the gate. The update 118 can further include any arbitrary information that the application related to the live activity to be included. For example, a change in a departure time may also be included in the update 118. The update 118 may also contain information indicating the new gate. Although the example provided here is with respect to a travel application, other applications may also have ongoing live activities, and generate updates to their respective live activities. For example, a navigation application may have an update, which may be for example, the next turn to take. A sports application may have an updates related to significant events in the underlying live activity of the sport match being played, such as a scoring point, a penalty, or an injury of a player.

The live activity display 112 can further display additional updates and/or messages related to the underlying live activity from the same application, or another application, over a period of time. In some embodiments, the live activity display 112 displays the update 118 as a first update in a plurality of updates or a sequence of updates. The update 118 may be configured to have multimedia elements contained therein to emphasize or visually display certain pieces of information. The live activity display 112 can further be configured to rearrange a presentation order of updates based on the update being a higher priority. For example, live activity display 112 can hold one or more messages unrelated to the live activity of the specific application related to update 118 prior to receiving the update 118. The updates unrelated to the specific live activity can be ordered based on various parameters, such as arrival time, priority of the underlying application, or the type of update (e.g., one in which a user must take an action versus one which is only informational for a user). Upon receipt of the update 118, the live activity display 112 can be configured to override the ordering parameter(s) such that the update 118 is displayed when received. In other words, live activity display 112 (or underlying system processes that control the display of updates on the live activity display 112) can be configured to implement a priority ordering parameter, in which the update 118 is displayed above any other updates. As an illustration, referring to FIG. 1, the live activity display 112 is displaying a message from a travel application.

The update 118 displayed on the live activity display 112 can be interactive, persistent, or configured to vanish after a period of time. For example, the update 118 can be tapped upon to present information from the application related to the update 118. For example, the user can interact with a portion of the update 118 displayed on the live activity display 112, that may present additional information related to the update 118. For instance, the update 118 may direct to a specific section with an application related to the update 118 being displayed. The interactivity of the update 118 may be arbitrary and based on the underlying application associated with the update 118.

The display of the update 118 on the live activity display 112 may be configured by the developer of the application for the specific device 100 and the live activity display 112. However, and as further explained herein, if the same update 118 was to be transmitted to an accessory device, the developer would require a version of the application to be installed on the accessory device. Additionally, the developer of the application may also have to configure the update 118 to be in a format that is displayable on an accessory device.

### II. Managing Updates to Live Activity on Accessory Device

As further explained herein, an update to a live activity, which may contain both textual and multimedia information, may be transmitted from a primary device (e.g., a mobile device) to an accessory device (e.g., a smart watch). A routine of the primary device may receive the update, and the primary device may develop a user interface of the update. The update and/or the user interface related to the update may be transmitted by developing a user interface for the update and transmitting it to the accessory device. The payload may be transmitted to a routine (e.g., system routine, a listener routine, an accessory routine), an accessory application, or another system application (or other companion application configured to receive and display updates to a live activity). In some examples, an accessory application may be downloaded installed as a portion of the software associated with the accessory to communicate with the accessory.

The generation of the user interface on the primary device may be done by a routine (e.g., system routine, a listener routine, an accessory routine) that is agnostic to the underlying application which has generated. Thus, the application need not be aware of whether or not the primary device is connected to an auxiliary device. The same user interface used to generate the live update on the primary device may thus be replicated by the routine and transmitted to the auxiliary device as a message.

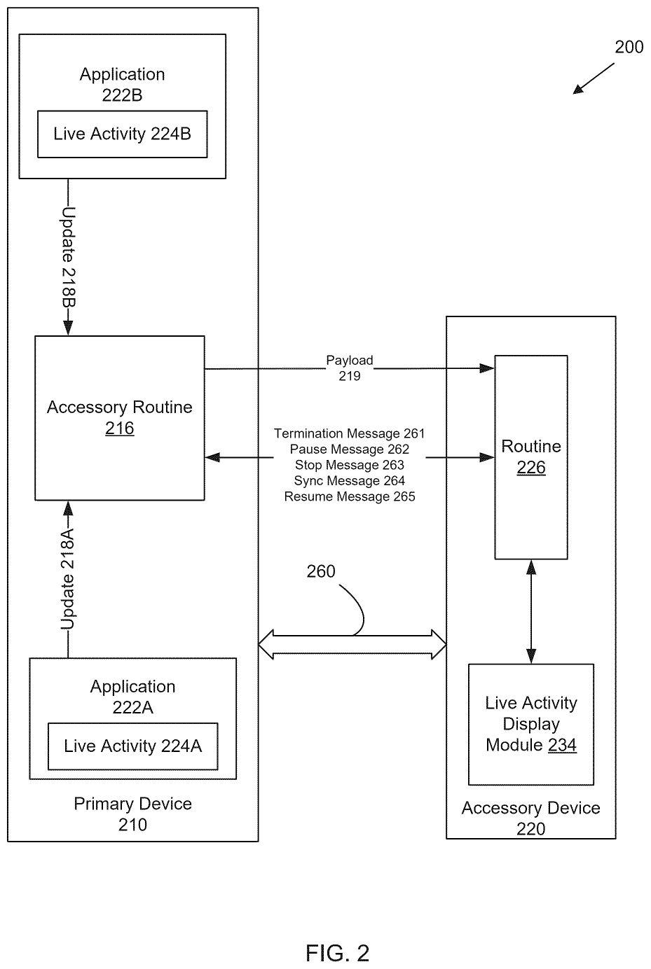

FIG. 2 is a block diagram of a system 200 illustrating a primary device and an accessory device according to an embodiment of the invention. Devices within the system 200 may be in communication with each other, such as a primary device 210 communicating with an accessory device 220. The primary device 210 may be similar to the mobile device 100. The primary device 210 may communicate with an auxiliary device 220, that may have relatively limited resources, in terms of computing power and data storage capacity, such as when the accessory device is a smart watch. However, in other examples, the accessory device 220 may be a device that is not currently in use or running an application that is generating live updates, such as for example, a laptop.

The auxiliary device 220 can be a wearable accessory device, for example. Wearable auxiliary devices can be implemented in any wearable article. For example, the auxiliary device 220 can be implemented as or within a watch, a bracelet, a necklace, a ring, a belt, a jacket, glasses, goggles, headphones, ear buds, hearing aids, or the like, or can be placed inside and attached to such articles. The primary device 210 and the auxiliary device 220 can be any kinds of portable electronic devices, such as a portable music player, a digital camera, a laptop computer, a tablet computer, a digital audio recorder, enhanced reality goggles, headphones, earpieces, or a smart phone, for example. The devices can be the same or different kinds of devices.

The primary device 220 may be running an applications 222A and 222B (collectively, applications 222). The applications 222A and 222B may be any user applications that are configured to be run on the primary device 220. The applications 222A and 222B may have processes that are running in the background of the primary device 220. In some examples, the applications 222A and 222B may be running in a minimized or background view, where the applications 222A and 222B are not being displayed on a display of the primary device 220. As one example, application 222A may be a sports application. The sports application may be running in the background, and obtaining updates to a sports match to which a user has subscribed. Application 222B may be a navigation application, that is running in the background, and obtaining updates to the route being navigated based on the location of the primary device 210.

The applications 222A and 222B may have a live activity 224A and a live activity 2224B, which are instantiated by the application 222A and the application 222B respectively. For example, the application 222A may instantiate a live activity 224A, that may operate independently of the live activity 224B instantiated by the application 222B. The live activities 224A or 224B may be instantiated responsive to a trigger (e.g., an external trigger) or responsive to criteria established within applications 222 (e.g., upon starting a check in process to board a flight). Returning to the example sports application, a sports match may be a considered to be a live activity that is being run on the application 222A.

The live activities 224A and 224B may have one or more updates that occur to the respective live updates. For example, an update 218A may be an update that occurs with respect to the live activity 224A. Update 218B may be an update that occurs with respect to the live activity 222B. Returning to the example sports application, a goal, a point, or other events in the sports match may be considered to be updates to the live activity (e.g., the sports match). As another example, approaching a turn may be an update to the live activity for a navigation app. The update 218A and the update 218B may be similar to update 118 that is displayed on the live activity display 112. Update 218 may be transmitted to a accessory routine 216. In some examples, the update 218A and the update 218B may occur asynchronously. In some examples, the update 218A and the update 218B may be generated close in time. Each update may have a priority associated with the update.

Updates 218A and 218B may be defined or contain content that defines a user interface or a display for a user. As one example, the user interface to display the update to the live activity may be constructed using a standardized format that is interpretable by the operating system and/or routines of the operating system of the primary device. As one example, SwiftUI may be used to generate, and/or to render UI components to display information related to an update as a visual on the primary device 210 and/or the accessory device 220. These views may be processed by a routine to display the update to the live activity. In some examples, the updates 218A and 218B may have interactivity components that are integrated into the updates.

Although only two updates from two application running one live activity respectively are illustrated in FIG. 2, it is to be understood that multiple applications, with multiple live activities may be running on the primary device 210, and be transmitted to the accessory routine 216. In some examples, the accessory routine 216 may be downloaded and installed on the primary device 210 as software that is bundled with the accessory device 220 to allow for communication with the accessory device 220.

The operating system or the accessory routine 216 may process the updates 218A and/or 218B to display the updates within a live activity display of the primary device 210. The accessory routine 216 may also create and transmit a payload 219 to the accessory device 220. For example, a single update from update 218A and 218B may be chosen by the accessory routine 216 for creating the payload 219. The payload 219 may be configured to be processed by a routine 226 of the accessory device 220. The payload 219 may contain at least data information that is equivalent to the data utilized to generate display the update to the live activity on the primary device 210. The routine 226 may receive the payload 219 and process the payload 219. The payload 219 may also contain authentication information, including metadata indicating the application generating the update to the live activity, metadata identifying the primary device 210, the priority of the live update, in addition to information related to rendering and/or the content related to the update to the live activity.

Routine 226 may be any sequence of instructions that perform interpretation of the payload 219. Routine 226 may be a low-level routine that may contain functions, subroutines, or procedures to process the payload 219 and cause the update to the live routine to be displayed on the accessory device 220. In some examples, routine 226 may be part of a third party application to process live updates. In other examples, routine 226 may be part of the operating system of the accessory device 220. In other examples, routine 226 may be installed as an update or as a background application on the accessory device 220 after pairing with the primary device 210. Routine 226 may handle low-level tasks such as managing hardware, memory, and system resources, to process the payload 219 and to provide information from the payload 219 for display on the accessory device 220. Routine 226 may also contain additional functions to validate the payload 219 as being generated from an authorized primary device 210.

In some examples, the routine 226 may execute in a “kernel mode” that may allow for additional access to system resources. In some examples, the routine 226 may execute in a user mode, where the routine 226 has limited access to system resources, but may be able to make a system call to a low level OS kernel and/or other modules of the accessory device to ensure that the live update is displayed over running applications and/or other visual elements of the display of the accessory device 220.

Routine 226 may also be able to receive other messages related to live updates. As one example, routine 226 may receive a termination message 261. The termination message 261 may be transmitted from the primary device 210 to the accessory device 220 to indicate that the particular live activity (e.g., live activity 224A) has been terminated, and that no further updates to the live activity are possible. Routine 226 may process this information to terminate the live activity on the accessory device. Additionally, the termination message 261 may also cause other aspects of the live activity (e.g., display within a smart stack of the accessory device) to be terminated.

While only one payload 219 is displayed in FIG. 2, the routine 226 may receive multiple payloads for multiple live updates over time. Routine 226 may process the multiple payloads in sequence, based on priority of the update, and/or other criteria. Similarly, multiple live updates may be generated and transmitted as payloads to the accessory device 220.

Payload 219, once processed by the routine 226 of the accessory device 220, may be displayed on the display of the accessory device 220. In some examples, one or more aspects of the payload may be processed by a live activity display module 234 of the accessory device 220. The routine 226 may interact with the live activity display module 234. The live activity display module 226 may be configured to process aspects of the payload 219 and make the payload 219 suitable for display on the accessory device 220. As one example, the live activity display module may create, by default, a notification style banner similar to the one described in FIG. 1 to be displayed or emulated on the accessory device 220 (e.g., when the accessory device is being used with another application). In some examples, the live activity display module 226 may display the live update on the entire or a majority of the display of the accessory device 220 (e.g., when the accessory device is not being used or in a default state). Different applications may have different formats and/or preferences for the display of updates to their live activities. For example, an application may specify that once sent to a smart stack, updates to the live activity for that application should not be displayed on the screen and only be on the smart stack (e.g., for a low priority live activity). A smart stack may be a display containing multiple updates or multiple live activities within one display, with each live activity having a dedicated portion of the smart stack, and each update to the live activity being rendered within the smart stack.

In some examples, the user may interact with the update to the live activity displayed on the auxiliary device in several manners. The interaction mechanisms may be defined or provided by the accessory routine 216 and/or the application 222. For example, the interaction mechanisms may include tapping to expand the live update to a larger portion of the display of the accessory device 220, swiping to remove the live update, interacting with a portion of the live update that may be linked to application specific information (e.g., an external URL, a link to a version of the application for the accessory device, or taking other actions with respect to the live update (e.g., sending a message to a friend through a message application present on the accessory device 220), swiping to push the live update to a smart stack, tapping and holding to pause or suspend receiving all further updates to the live activity (e.g., for a specific application), or blocking a particular live activity from being displayed on the accessory device 220.

In some examples, payload 219 may also contain an identifier of the application 222A or application 222B, so that a version of the application may be identified by the accessory device 220. In some examples, the payload 219 may also contain information that is specific to the accessory device 220. For example, if the accessory device 220 is a watch that may have multiple physical input buttons, the live update may be configured such that each physical input button may perform a fixed function (e.g., dismissing the live update, moving it to the smart stack, etc.) or a specific function that may be defined by the accessory routine 216 (e.g., for a specific live updates expanding the live update). In some examples, the accessory routine 216 may be agnostic to the type of accessory device, and deliver a payload to multiple accessory devices. Yet, in other examples, the accessory routine 216 may be aware of or identify the accessory device, and configure the payload 216 with metadata and/or features that are specific to the accessory device 220. In yet other examples, the routine 226 of the accessory device 220 may enable the additional functionality by processing the payload 219. However, in all of these examples, there is no need for the applications 222 (or a version of those applications for the accessory device 220) to be installed or even available for the accessory device 220 for the live update to be displayed on the accessory device.

Payload 219 may also contain other information related to the live update. For example, a specific tone that is related to the live update, haptic feedback related to the live update (e.g., a specific vibration sequence), and/or other specific behavior related to the live update, may be emulated on the accessory device 220.

The double-headed arrows 260 in FIG. 2 indicate network connections for communication between the primary device 210 and the accessory device 220. The connections may comprise a wired network connection, or a wireless network connection, or a combination of the two types of connection.

In some examples, a user interaction recorded or registered on the accessory device may be provided to the primary device. For example, a message that indicates that a notification was viewed on dismissed on the accessory device may be provided to the primary device. For example, a termination message 261, a pause message 262, a stop message 263, and a synchronization message 264 are illustrated as example messages that may be transmitted between the accessory routine 216 and the routine 226. The termination message may indicate to terminate live activity processes. The pause message 262 may pause transmission of further payloads containing live messages in the future. The stop message 263 may stop the transmission of further live updates, and may be initiated by either the accessory routine 216 or the routine 226. The stop message 263 may stop further updates but not terminate the live activity. A synchronization message 264 may cause an action taken on the accessory device to be synchronized to the primary device. A resume message may cause resuming the transmission of live updates between devices. For example, if a user views a live update, dismisses a live update, or provides input indicating that he wishes to terminate the live activity, a synchronization message may be sent from the accessory device to the primary device to synchronize the live activity on both devices. It may be noted that application 222A and application 222B (or versions thereof suitable for the accessory device) need not be present on the accessory device to provide the functionality described herein. It is to be understood that these messages are exemplary, and other messages may be configured to control and/or modify the live activity update process.

### III. Methods for Providing Live Updates

Live updates can be transmitted from a first device (e.g., a primary device) to a second device (e.g., an accessory device). As further discussed herein, methods may be performed by the first device to transmit live updates. The second device may receive live updates, and transmit messages which may modify live updates, or interact with the live updates.

### A. Example Method by a Primary Device

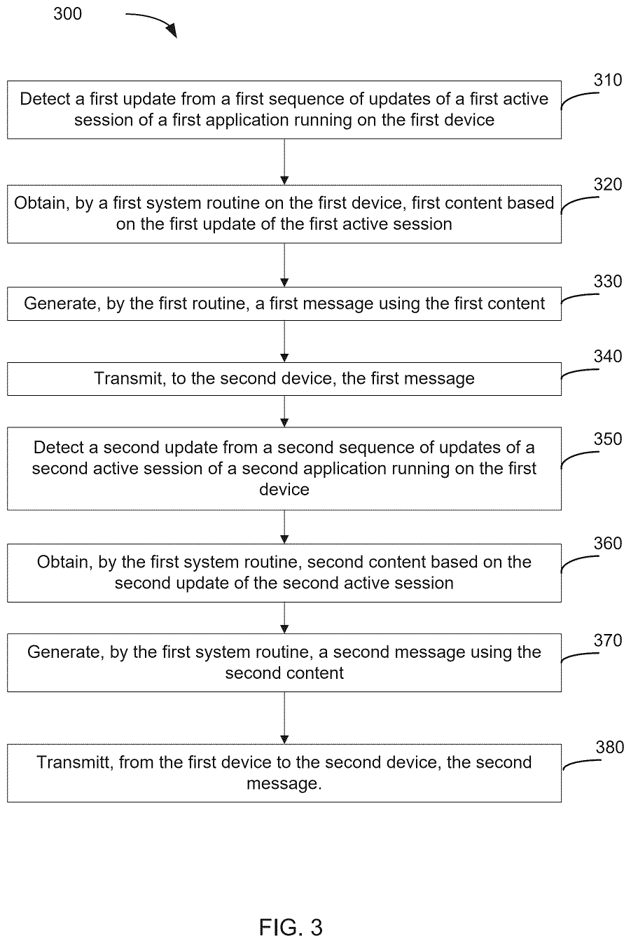

FIG. 3 is a flowchart of a method 300 for providing live updates related to certain embodiments of the present disclosure. Method 300 may allow live updates from a first application and a second application to be transmitted to the second device.

At block 310, a first update from a from a first sequence of updates of a first active session of a first application running on the first device may be detected. This first update may the an update from a sequence of updates that occur during a first active session of a first application running on the first device. A routine, an application, a system process, or other element of the first device may continuously monitor for updates transmitted from the first application to identify any changes that are identified as a live update. These updates could be related to various aspects of the first application, such as user interactions, changes in content, system notifications, or other relevant events that the application handles during its active session. The first update may also be displayed on the first device as a live update. For example, the first update may be similar to the update 118 and may be displayed on a live activity display, similar to the live activity display 118, of the mobile device 100. The first active session and the second active session may be similar to the live activity 224A and the live activity 224B respectively. The first application and the second application may also be similar to application 222A and 222B respectively.

At block 320, the first routine on the first device may obtain a first content based on the first update of the first active session. The first content may be content that contains animations, multimedia content, haptic information, and textual information. The first content may cause the animations, multimedia, and the text to be presented on the first device. The first application may define parameters of how the first content is displayed. As explained above, the first content may be the same as the content that is presented for display on the first device.

At block 330, the first routine may generate, a first message using the first content. The first message may be configured to be interpretable by a second routine of a second device and to cause the second device to display the first content. The second routine of the second device may be similar to routine 226 described above. In some examples, the second routine may instead be a third-party application that is designed to receive and display live updates. In some examples, such as when the first device or the second device are in a particular device state (e.g., screen off, low power, etc.) the content for the first update may be generated in a different manner compared to when the device is not in that particular state.

At block 340, the first message may be transmitted to the second device. The first message may be transmitted from a first routine (e.g., accessory routine 216) of the first device to the second routine (e.g., routine 226) of the second device. The first routine and the second routine may be in communication with one another through a communication interface (e.g., Bluetooth, Wi-Fi, near-field communication, etc.). In some examples, the first message may be broken into parts, that may be transmitted sequentially. Each part of the first message may have a piece of content that may allow the live update to be displayed on the accessory device.

At block 350, a second update from a second sequence of updates of a second active session of a second application running on the first device may be detected. The first application and the second application may be running independently from one another. The second update may thus be completely independent of the first update. The second update may be displayed on the first device, replacing the display of the first update.

At block 360, the first routine may obtain a second content based on the second update of the second active session. The second content may be similar to the first content but may differ in that it is generated by the second application. In some examples, the second content may have a different visual style, display characteristics, visuals, animations, and persistency rules (e.g., how long the second content is displayed, how it may fade away, etc.) compared to the first content.

At block 370, the first routine may generate, a second message using the second content. The second message may be similar to the first message, but may differ in that has varying content.

At block 380, the first device may transmit to the second device, the second message. The second message may be transmitted from a first routine (e.g., accessory routine 216) of the first device to the second routine (e.g., routine 226) of the second device. The second routine of the second device may be able to process the message to allow the content of the message to be displayed on the second device.

In some embodiments, the first device may transmit a termination message (e.g., termination message 261) to the second device. The termination message may enable the termination of the active session on the accessory device. For example, the termination message may terminate, at the second routine of the second device, any processes related to displaying the first active session or live updates related to the first active session. In some examples, a frequency of transmission of messages related to the first active session or the second active session may be modified based on the state of the first device or the state of the second device. In some examples, the first application or the second applications may specify a characteristic value. The characteristic value may modify visualization of the first content on the second device. The characteristic value may modify the opacity, how long the live update appears on the second device, how the live update is expanded or contracted, etc. The characteristic value may be different than the underlying content.

In some embodiments, a third update (e.g., the third update being a subsequent update to the first active session of a first application running on the first device) and a fourth update (e.g., the fourth update being a subsequent update to the second active session of a second application running on the first device may be detected). The third update and the fourth update may be transmitted to the second device (e.g., accessory device 220) through a third message and a fourth message respectively, and in a manner similar to the generating of the first message and the second message. Each message may also terminate the display of a previous live activity. In some examples, the previous live activity may complete in being displayed prior to the display of a subsequent update of another update. In some examples, the most recent update to a specific active session may be displayed, overriding the display of previous live activities.

### A. Example Method by an Accessory Device

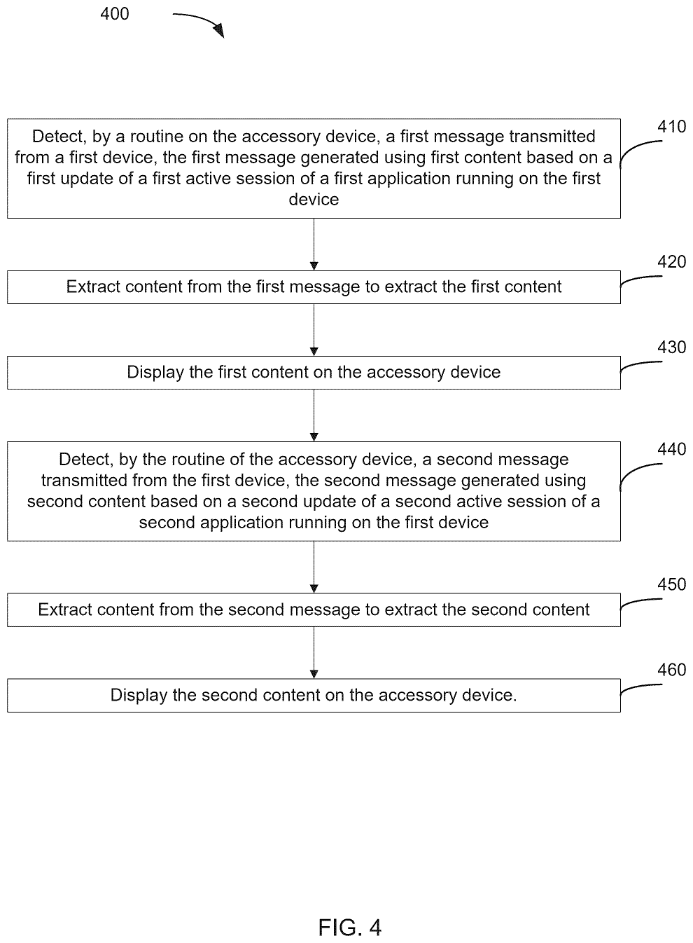

FIG. 4 is a flowchart of a method 400 for providing live updates according to certain embodiments of the present disclosure. In some embodiments, method 400 may be performed by a second device (e.g., an accessory device). This method may be performed to allow the second device to receive live updates, render the live update, and allow for interactions, and control of the live update.

At block 410, a routine of a second device (e.g., an accessory device) may detect and/or receive a first message. The first message may have been transmitted from a first device. The first device may have generated the first message using first content based on a first update of a first active session of a first application running on the first device.

At block 420, the routine on the second device (e.g., an accessory device) may extract the first content from the first message. In some embodiments, the first content and the second content may contain animations. The first content may be embedded within the first message, and be extracted and processed to be displayed on the second device.

At block 430, the second device (e.g., an accessory device) may display the first content. The content may be displayed in a manner that may be consistent with the content being displayed on the primary device. In some examples, the content may also have additional interaction options once displayed, such as tapping, swiping the content,

At block 440, the routine on the second device (e.g., an accessory device) may detect a second message. The second message may be similar to the first message. The second message may be generated using second content based on a second update of a second active session of a second application running on the first device.

At block 450, the second message may extract the second content. The second content may be derived and/or related to the second application which is running on the first device. The second content may thus be differentiated from the first content. As an example, the first content may be related to a navigation application while the second content may be related to a sports application.

At block 460, the second content may be displayed on the accessory device. One or more routines of the accessory device may cause the accessory device to display the content. The one or more routines may extract metadata related to the second message to display the second content in a particular manner. The second content may be similar to the first content but may differ in that it is generated by the second application. In some examples, the second content may have a different visual style, display characteristics, visuals, animations, and persistency rules (e.g., how long the second content is displayed, how it may fade away, etc.) compared to the first content. In some embodiments, the first content and the second content may contain animations.

In some embodiments, the second device (e.g., an accessory device) may transmit to the first device, one or more types of messages which may modify the generation, transmission, and/or running of live updates. For example, a pause message (e.g., pause message 262) may be configured to cause the first device to pause the transmission of additional updates from the first active session of a first application to the accessory device. The pause message (e.g., pause message 262) may be generated based upon on the state of the accessory device. The accessory device may additionally or alternatively transmit to the first device, a resume message. The resume message (e.g., resume message 265) may be configured to cause the first device to resume the transmission of additional updates from the first active session of a first application to the accessory device. A stop message (e.g., stop message 264) may be transmitted from the accessory device to the first device. The stop message may be configured to cause the first device to terminate the transmission of additional updates from the first active session of a first application. The stop message may be generated based on a state of the accessory device.

In some examples, a user interaction recorded or registered on the accessory device may be provided to the primary device. For example, a message that indicates that a notification was viewed on dismissed on the accessory device may be provided to the primary device. This information may be embedded in a synchronization message (e.g., sync message 264). This may synchronize a user interaction or user input with respect to content or a live activity across the first device and the second device.

Additional aspects of modifying the content, the frequency of updates, and timing of updates between a primary device and a second device are provided below.

### IV. Modification of Updates

In some examples, the state of an accessory device or the primary device may be evaluated or provided, and may be used as a basis for determining how live updates are provided to an accessory device.

In some examples, the generation and transmission of updates to a live activity may be modified based on power constraints, processing constraints, of device states of the primary device or the accessory device. As discussed herein, power constraints, data synchronization between devices, and data fidelity may be evaluated.

a. Modifying Updates Based on Device State(s)

In some examples, the primary device or the auxiliary device may modify the transmission of payloads between the primary device and the accessory device. As one example, a system routine or other application of the primary device may dynamically adjust the update frequency, payload, or other information related to the update of the live activity based on the battery level and power mode of the accessory device. For instance, in low power mode or when connected over an energy intensive protocol (e.g., a cellular protocol, an active mode (e.g., a sports mode), the auxiliary device (e.g., smartwatch) may request a reduced update rate from the primary device (e.g., mobile device) to preserve energy and conserve battery life. The phone, in turn, may only send updates from certain applications, or only certain critical updates to the auxiliary device under these conditions. For example, in a sports application, the display might show a running clock and live updates when fully powered, but switch to a less detailed view when in low power mode.

In some examples, the routine of the primary device may configure a payload for delivery to the auxiliary device depending on the state of the auxiliary device. For example, in a low power state, a developer may have a simplified rendering of the update for display on the auxiliary device. In some examples, an update may not be transmitted to the smartwatch depending on one or more device states of the primary device or the auxiliary device. For example, developers can specify how information should be displayed on the auxiliary device (e.g., smartwatch) depending on a state of the auxiliary device. As an example, for a smartwatch, states such as off wrist, locked, or in sleep mode may be considered prior to transmitting updates to the smart watch. Such checks may ensure that the user interface remains functional and relevant without overburdening the auxiliary device's resources.

The primary device and/or the auxiliary device may also generate and/or obtain pre-determined customization of views without the need for real-time processing on the smartwatch. This pre-configuration enables the watch to adjust its display based on the current context (e.g., power state, connectivity) without running additional processes, that can be power-intensive. For instance, a sports app might predefine that in lower fidelity modes, the display of an auxiliary device may remove a “running clock” related to a sports game. This may also avoid an unrealistic display if the auxiliary device loses connectivity with the primary device.

### B. Modifying Update Frequency

In some examples, the update frequency is dynamically adjusted based on several factors, including the auxiliary device's battery level, connectivity status, and current mode (e.g., low power mode, cellular connection).

When the smartwatch is in a normal operating mode and connected to the primary device via a stable connection, it can receive updates at a higher frequency. This is particularly important for applications that require real-time data, such as sports apps displaying live scores and play-by-play updates. In this scenario, the smartwatch can display these updates almost instantaneously, providing users with a seamless and up-to-date experience.

However, in situations where the smartwatch is in low power mode or connected over a cellular network, the update frequency may be reduced to conserve battery life. For example, if the auxiliary device is running low on battery, it might only receive critical updates, such as significant changes in game scores or essential notifications (e.g., arrival of a ride or flight status changes). As the primary device may be agnostic to the nature of the update, this may be provided to a routine (e.g., a system routine) of the primary device as metadata. This may ensure that the smartwatch remains operational for as long as possible without rapid battery depletion.

In some examples, developers of an application may specify different update cadences for various types of data. For instance, a rideshare app might require frequent updates to show the location of a vehicle, whereas a fitness app might only need periodic updates to display activity progress. By allowing developers to tailor the update frequency according to the nature of the data, the system ensures efficient use of resources while meeting the specific needs of different applications.

In addition to adjusting the frequency of updates, competing or simultaneous updates may be prioritized based on their importance. Critical updates that may require immediate user attention are transmitted more promptly, while less critical updates can be deferred or sent at a lower frequency. This prioritization mechanism may ensure that users receive the most relevant information promptly, even when the device is operating under constrained conditions.

### V. Example API Architecture and Methods

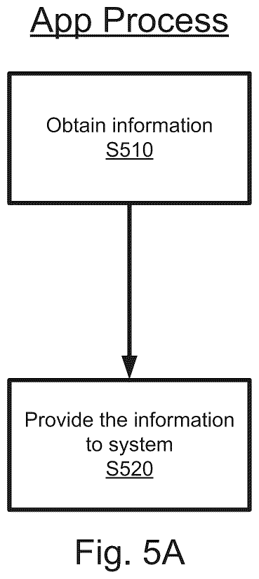

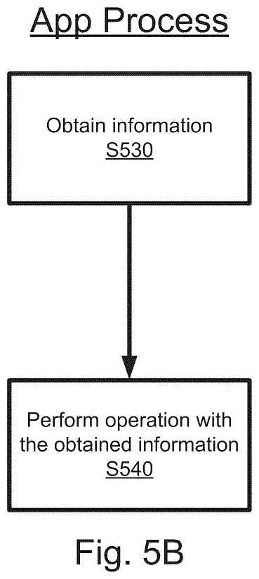

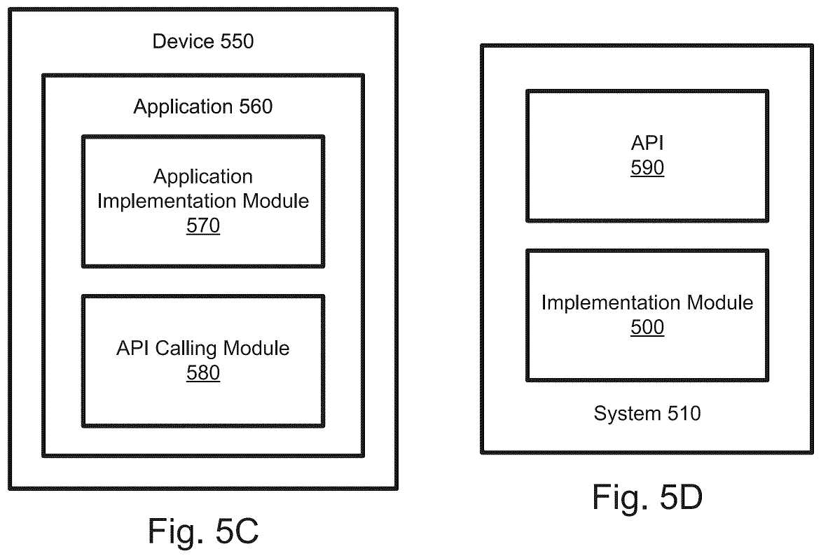

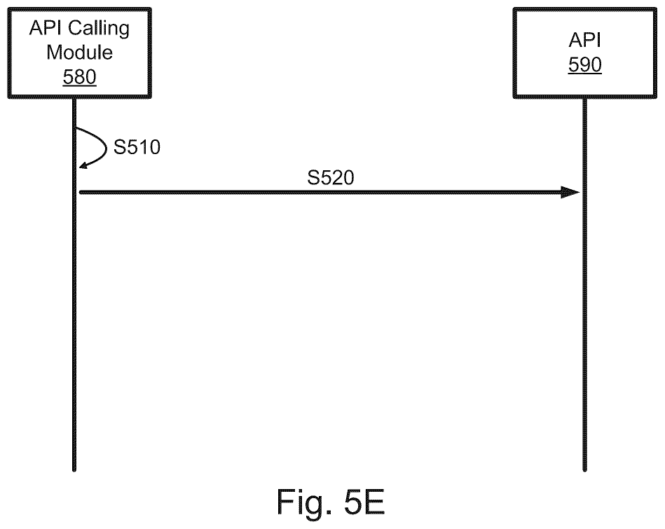

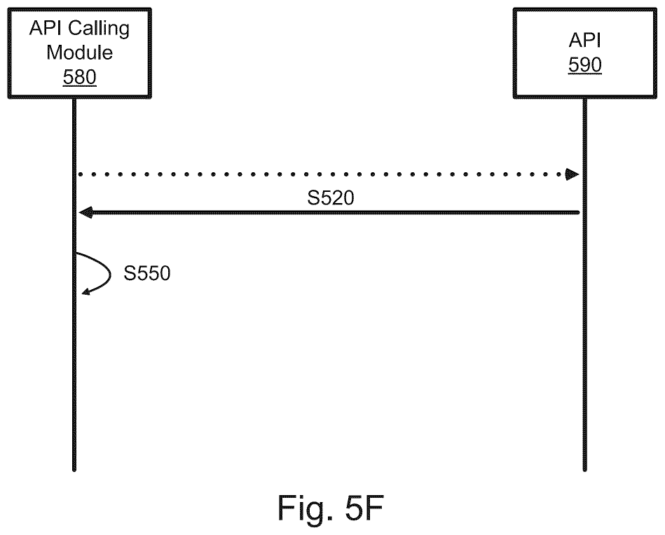

FIGS. 5A-5F is a flowchart of a method related to various embodiments related to API support.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 560) that, when executed by one or more processing units, control an electronic device (e.g., device 550) to perform the method of FIG. 5A, the method of FIG. 5B, and/or one or more other processes and/or methods described herein.

It should be recognized that application 560 (shown in FIG. 5C) can be any suitable type of application, including, for example, one or more of: an accessory device, an accessory communication application, a browser application, an application that functions as an execution environment for plug-ins, widgets or other applications, a fitness application, a health application, a digital payments application, a media application, a social network application, a messaging application, and/or a maps application. In some embodiments, application 560 is an application that is pre-installed on device 550 at purchase (e.g., a first party application). In other embodiments, application 560 is an application that is provided to device 550 via an operating system update file (e.g., a first party application or a second party application). In other embodiments, application 560 is an application that is provided via an application store. In some embodiments, the application store can be an application store that is pre-installed on device 550 at purchase (e.g., a first party application store). In other embodiments, the application store is a third-party application store (e.g., an application store that is provided by another application store, downloaded via a network, and/or read from a storage device).

Referring to FIG. 5A and FIG. 5E, application 560 obtains information (e.g., S510). In some embodiments, at S510, information is obtained from at least one hardware component of the device 550. In some embodiments, at S510, information is obtained from at least one software module of the device 550. In some embodiments, at S510, information is obtained from at least one hardware component external to the device 550 (e.g., a peripheral device, an accessory device, a server, etc.). In some embodiments, the information obtained at S510 includes positional information, time information, notification information, user information, environment information, electronic device state information, weather information, media information, historical information, event information, hardware information, and/or motion information. In some embodiments, in response to and/or after obtaining the information at S510, application 560 provides the information to a system (e.g., S520).

In some embodiments, the system (e.g., 510 shown in FIG. 5D) is an operating system hosted on the device 550. In some embodiments, the system (e.g., 510 shown in FIG. 5D) is an external device (e.g., a server, a peripheral device, an accessory, a personal computing device, etc.) that includes an operating system.

Referring to FIG. 5B and FIG. 5F, application 560 obtains information (e.g., S530). In some embodiments, the information obtained at S530 includes positional information, time information, notification information, user information, environment information electronic device state information, weather information, media information, historical information, event information, hardware information and/or motion information. In response to and/or after obtaining the information at S530, application 560 performs an operation with the information (e.g., S540). In some embodiments, the operation performed at S540 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 510 based on the information.

In some embodiments, one or more steps of the method of FIG. 5A and/or the method of FIG. 5B is performed in response to a trigger. In some embodiments, the trigger includes detection of an event, a notification received from system 510, a user input, and/or a response to a call to an API provided by system 510.

In some embodiments, the instructions of application 560, when executed, control device 550 to perform the method of FIG. 5A and/or the method of FIG. 5B by calling an application programming interface (API) (e.g., API 590) provided by system 510. In some embodiments, application 560 performs at least a portion of the method of FIG. 5A and/or the method of FIG. 5B without calling API 590.

In some embodiments, one or more steps of the method of FIG. 5A and/or the method of FIG. 5B includes calling an API (e.g., API 590) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 5C, device 550 is illustrated. In some embodiments, device 550 is a personal computing device, a smart phone, a smart watch, a fitness tracker, a head mounted display (HMD) device, a media device, a communal device, a speaker, a television, and/or a tablet. As illustrated in FIG. 5C, device 550 includes application 560 and operating system (e.g., system 510 shown in FIG. 5D). Application 560 includes application implementation module 570 and API calling module 580. System 510 includes API 590 and implementation module 500. It should be recognized that device 550, application 560, and/or system 510 can include more, fewer, and/or different components than illustrated in FIGS. 5C and 5D.

In some embodiments, application implementation module 570 includes a set of one or more instructions corresponding to one or more operations performed by application 560. For example, when application 560 is a messaging application, application implementation module 570 can include operations to receive and send messages. In some embodiments, application implementation module 570 communicates with API calling module to communicate with system 510 via API 590 (shown in FIG. 5D).

In some embodiments, API 590 is a software module (e.g., a collection of computer-readable instructions) that provides an interface that allows a different module (e.g., API calling module 580) to access and/or use one or more functions, methods, procedures, data structures, classes, and/or other services provided by implementation module 500 of system 510. For example, API-calling module 580 can access a feature of implementation module 500 through one or more API calls or invocations (e.g., embodied by a function or a method call) exposed by API 590 and can pass data and/or control information using one or more parameters via the API calls or invocations. In some embodiments, API 590 allows application 560 to use a service provided by a Software Development Kit (SDK) library. In other embodiments, application 560 incorporates a call to a function or method provided by the SDK library and provided by API 590 or uses data types or objects defined in the SDK library and provided by API 590. In some embodiments, API-calling module 580 makes an API call via API 590 to access and use a feature of implementation module 500 that is specified by API 590. In such embodiments, implementation module 500 can return a value via API 590 to API-calling module 580 in response to the API call. The value can report to application 560 the capabilities or state of a hardware component of device 550, including those related to aspects such as input capabilities and state, output capabilities and state, processing capability, power state, storage capacity and state, and/or communications capability. In some embodiments, API 590 is implemented in part by firmware, microcode, or other low level logic that executes in part on the hardware component.

In some embodiments, API 590 allows a developer of API-calling module 580 (which can be a third-party developer) to leverage a feature provided by implementation module 500. In such embodiments, there can be one or more API-calling modules (e.g., including API-calling module 580) that communicate with implementation module 500. In some embodiments, API 590 allows multiple API-calling modules written in different programming languages to communicate with implementation module 500 (e.g., API 590 can include features for translating calls and returns between implementation module 500 and API-calling module 580) while API 590 is implemented in terms of a specific programming language. In some embodiments, API-calling module 580 calls APIs from different providers such as a set of APIs from an OS provider, another set of APIs from a plug-in provider, and/or another set of APIs from another provider (e.g., the provider of a software library) or creator of the another set of APIs.

Examples of API 590 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 550. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 500 is a system (e.g., operating system, server system) software module (e.g., a collection of computer-readable instructions) that is constructed to perform an operation in response to receiving an API call via API 590. In some embodiments, implementation module 500 is constructed to provide an API response (via API 590) as a result of processing an API call. By way of example, implementation module 500 and API-calling module 180 can each be any one of an operating system, a library, a device driver, an API, an application program, or other module. It should be understood that implementation module 500 and API-calling module 580 can be the same or different type of module from each other. In some embodiments, implementation module 500 is embodied at least in part in firmware, microcode, or other hardware logic.

In some embodiments, implementation module 500 returns a value through API 590 in response to an API call from API-calling module 580. While API 590 defines the syntax and result of an API call (e.g., how to invoke the API call and what the API call does), API 590 might not reveal how implementation module 500 accomplishes the function specified by the API call. Various API calls are transferred via the one or more application programming interfaces between API-calling module 580 and implementation module 500. Transferring the API calls can include issuing, initiating, invoking, calling, receiving, returning, and/or responding to the function calls or messages. In other words, transferring can describe actions by either of API-calling module 580 or implementation module 500. In some embodiments, a function call or other invocation of API 590 sends and/or receives one or more parameters through a parameter list or other structure.

In some embodiments, implementation module 500 provides more than one API, each providing a different view of or with different aspects of functionality implemented by implementation module 500. For example, one API of implementation module 500 can provide a first set of functions and can be exposed to third party developers, and another API of implementation module 500 can be hidden (e.g., not exposed) and provide a subset of the first set of functions and also provide another set of functions, such as testing or debugging functions which are not in the first set of functions. In some embodiments, implementation module 500 calls one or more other components via an underlying API and thus be both an API calling module and an implementation module. It should be recognized that implementation module 500 can include additional functions, methods, classes, data structures, and/or other features that are not specified through API 590 and are not available to API calling module 580. It should also be recognized that API calling module 580 can be on the same system as implementation module 500 or can be located remotely and access implementation module 500 using API 590 over a network. In some embodiments, implementation module 500, API 590, and/or API-calling module 580 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, method 300 (FIG. 3) and method 400 (FIG. 4) are performed at a first computer system (as described herein) via a system process (e.g., an operating system process, a server system process) that is different from one or more applications executing and/or installed on the first computer system.

In some embodiments, method 300 (FIG. 3) and method 400 (FIG. 4) are performed at a first computer system (as described herein) by an application that is different from a system process. In some embodiments, the instructions of the application, when executed, control the first computer system to perform method 300 (FIG. 3) and method 400 (FIG. 4) by calling an application programming interface (API) provided by the system process. In some embodiments, the application performs at least a portion of method 300 and method 400 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 300 (FIG. 3) and method 400 (FIG. 4) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 590 defines a first API call that can be provided by API calling module 590, wherein the definition for the first API call specifies the following call parameters: frequency, state of the watch, format, encoding, characteristic, message size, message priority, update priority, device state. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 550) that runs the application. In some embodiments, the implementation module is included in an electronic device that is separate from the device that runs the application.

### VI. Example Computing Device

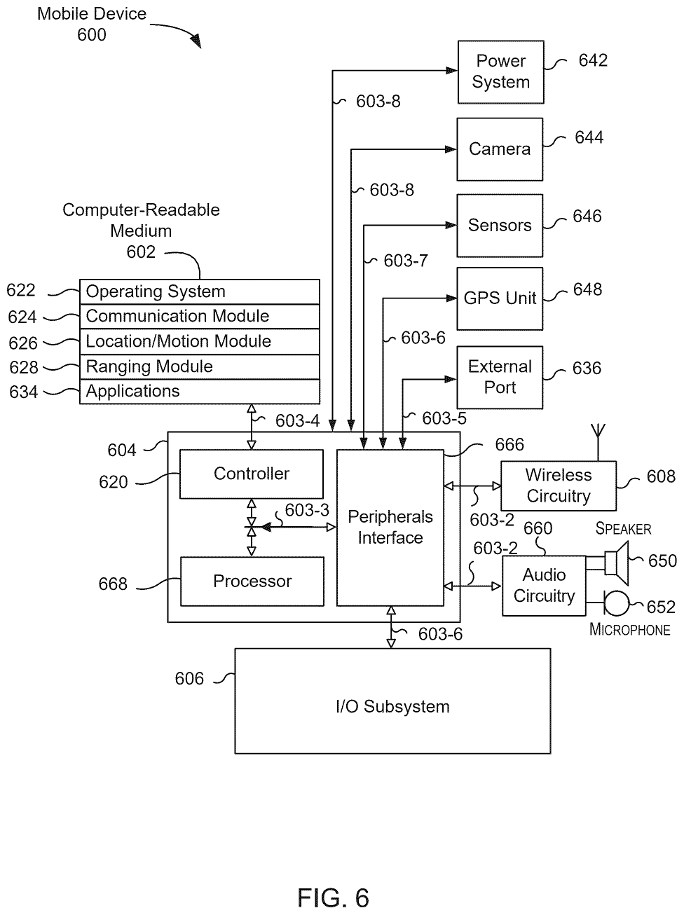

FIG. 6 is a block diagram of an example electronic device 600 according to at least one embodiment. Device 600 generally includes computer-readable medium 602, a processing system 604, an Input/Output (I/O) subsystem 606, wireless circuitry 608, and audio circuitry 610 including speaker 612 and microphone 614. These components may be coupled by one or more communication buses or signal lines 603. Device 600 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

It should be apparent that the architecture shown in FIG. 6 is only one example of an architecture for device 600, and that device 600 can have more or fewer components than shown, or a different configuration of components. The various components shown in FIG. 6 can be implemented in hardware, software, or a combination of both hardware and software, including one or more signal processing and/or application specific integrated circuits.

Wireless circuitry 608 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 608 can use various protocols, e.g., as described herein. In various embodiments, wireless circuitry 608 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 608 is coupled to processing system 604 via peripherals interface 616. Peripherals interface 616 can include conventional components for establishing and maintaining communication between peripherals and processing system 604. Voice and data information received by wireless circuitry 608 (e.g., in speech recognition or voice command applications) is sent to one or more processors 618 via peripherals interface 616. One or more processors 618 are configurable to process various data formats for one or more application programs 634 stored on medium 602.

Peripherals interface 616 couple the input and output peripherals of device 600 to the one or more processors 618 and computer-readable medium 602. One or more processors 618 communicate with computer-readable medium 602 via a controller 620. Computer-readable medium 602 can be any device or medium that can store code and/or data for use by one or more processors 618. Computer-readable medium 602 can include a memory hierarchy, including cache, main memory and secondary memory. The memory hierarchy can be implemented using any combination of random access memory (RAM) (e.g., static random access memory (SRAM), dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 616, one or more processors 618, and controller 620 can be implemented on a single chip, such as processing system 604. In some other embodiments, they can be implemented on separate chips.

Processor(s) 618 can include hardware and/or software elements that perform one or more processing functions, such as mathematical operations, logical operations, data manipulation operations, data transfer operations, controlling the reception of user input, controlling output of information to users, or the like. Processor(s) 618 can be embodied as one or more hardware processors, microprocessors, microcontrollers, field programmable gate arrays (FPGAs), application-specified integrated circuits (ASICs), or the like.

Device 600 also includes a power system 642 for powering the various hardware components. Power system 642 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 600 includes a camera 644. In some embodiments, device 600 includes sensors 646. Sensors can include accelerometers, compass, gyrometer, pressure sensors, audio sensors, light sensors, barometers, and the like. Sensors 646 can be used to sense location aspects, such as auditory or light signatures of a location.

In some embodiments, device 600 can include a GPS receiver, sometimes referred to as a GPS unit 648. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 618 run various software components stored in medium 602 to perform various functions for device 600. In some embodiments, the software components include an operating system 622, a communication module 624 (or set of instructions), a location module 626 (or set of instructions), an offline maps module 628 that is used as part of downloading offline maps as described herein, and other application programs 634 (or set of instructions).

Operating system 622 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 624 facilitates communication with other devices over one or more external ports 636 or via wireless circuitry 608 and includes various software components for handling data received from wireless circuitry 608 and/or external port 636. External port 636 (e.g., universal serial bus (USB), FireWire, Lightning connector, 60-pin connector, etc.) is adapted for coupling directly to other devices or indirectly over a network (e.g., the Internet, wireless local area network (LAN), etc.).

Location/motion module 626 can assist in determining the current position (e.g., coordinates or other geographic location identifiers) and motion of device 600. Modern positioning systems include satellite-based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 626 receives data from GPS unit 648 and analyzes the signals to determine the current position of the mobile device. In some embodiments, location/motion module 626 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 608 and is passed to location/motion module 626. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 600 based on the position coordinates of the corresponding transmitters. Regardless of the specific location technology used, location/motion module 626 receives information from which a location fix can be derived, interprets that information, and returns location information, such as geographic coordinates, latitude/longitude, or other location fix data.

The offline maps module 628 may send and/or receive map and/or service data messages to/from an antenna, e.g., connected to wireless circuitry 608. The map and or service data may be used by one or more services, including a routing service, a vector tiles service, a search service, and other such services. The offline maps module 628 can exist on various processors of the device, e.g., an always-on processor (AOP), a UWB chip, and/or an application processor.

The one or more applications 634 on device 600 can include any applications installed on the device 600, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 606 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 606 can include a display and user input devices such as a keyboard, mouse, and/or trackpad. In some embodiments, I/O subsystem 606 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 602) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 606 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 600 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid-state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including proximity messages and data from which the proximity message is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine a dwell spot using distance measurements that track a user through their daily routine. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method of providing an update from an active session to a user, the method comprising performing, by a first device:
detecting a first update from a first sequence of updates of a first active session of a first application running on the first device;
obtaining, by a first routine on the first device, first content based on the first update of the first active session;
generating, by the first routine, a first message using the first content, the first message configured to be interpretable by a second routine of a second device and to cause the second device to display the first content;
transmitting, to the second device, the first message;
subsequently, detecting a second update from a second sequence of updates of a second active session of a second application running on the first device;
obtaining, by the first routine, second content based on the second update of the second active session;
generating, by the first routine, a second message using the second content, the second message configured to be interpretable by the second routine and to cause the second device to display the second content; and
transmitting, from the first device to the second device, the second message.

2. The method of claim 1 further comprising transmitting a termination message to the second device, the termination message causing the termination of the first active session or of the second active session.

3. The method of claim 1 wherein the first routine is a system routine of the first device.

4. The method of claim 1 further comprising displaying, on the first device, the first update from the first sequence of updates and the second update from the second sequence of updates.

5. The method of claim 4 wherein the first content and the second content are displayed sequentially on the first device.

6. The method of claim 1 further comprising detecting, a state of the first device or a state of the second device, and modifying one or more aspects related to the first message or the second message.

7. The method of claim 6 further comprising, modifying, a frequency of transmission of messages related to the first active session or the second active session based on the state of the first device or the state of the second device.

8. The method of claim 6 further comprising, modifying, metadata of the first message or metadata of the second message based on the state of the first device or the state of the second device.

9. The method of claim 6 further comprising, modifying, the first content or the second content based on the state of the first device or the state of the second device.

10. The method of claim 1 wherein the first application specifies a characteristic, the characteristic modifying a visualization of the first content on the second device.

11. The method of claim 1 further comprising:
detecting a third update from the first sequence of updates of a first active session of a first application running on the first device;
obtaining, by a first routine on the first device, third content based on the third update of the first active session;
generating, by the first routine, a third message using the third content, the third message configured to be interpretable by a second routine of a second device and to cause the second device to display the third content; and
transmitting, to the second device, the third message.

12. The method of claim 11 further comprising:
detecting a fourth update from a second sequence of updates of a second active session of a second application running on the first device;
obtaining, by the first routine, fourth content based on the fourth update of the second active session;
generating, by the first routine, a fourth message using the fourth content, the fourth message configured to be interpretable by the second routine and to cause the second device to display the fourth content; and
transmitting, from the first device to the second device, the fourth message.

13. The method of claim 12 wherein the first message, the second message, the third message, and the fourth message are processed sequentially on the second device, wherein the first message, second message, third message, and fourth message contain a time value indicating how long the message is to be displayed on the second device.

14. The method of claim 12 wherein the second message is configured to terminate the display of the first message on the second device.

15. A non-transitory computer readable medium containing instructions that, when executed by one or more processors, cause the one or more processors to perform operations including:
detecting a first update from a first sequence of updates of a first active session of a first application running on the first device;
obtaining, by a first routine on the first device, first content based on the first update of the first active session;
generating, by the first routine, a first message using the first content, the first message configured to be interpretable by a second routine of a second device and to cause the second device to display the first content;
transmitting, to the second device, the first message;
subsequently, detecting a second update from a second sequence of updates of a second active session of a second application running on the first device;
obtaining, by the first routine, second content based on the second update of the second active session;
generating, by the first routine, a second message using the second content, the second message configured to be interpretable by the second routine and to cause the second device to display the second content; and
transmitting, from the first device to the second device, the second message.

16. The non-transitory computer readable medium containing instructions of claim 15 wherein the first routine is a system routine of the first device.

17. The non-transitory computer readable medium containing instructions of claim 15 the instructions further comprising displaying, on the first device, the first update from the first sequence of updates and the second update from the second sequence of updates.

18. The non-transitory computer readable medium containing instructions of claim 15 the instructions further comprising detecting, a state of the first device or a state of the second device, and modifying one or more aspects related to the first message or the second message.

19. A first device comprising one or more processors and non-transitory computer readable medium containing instructions that, when executed by one or more processors, cause the device to perform operations including:
detecting a first update from a first sequence of updates of a first active session of a first application running on the first device;
obtaining, by a first routine on the first device, first content based on the first update of the first active session;
generating, by the first routine, a first message using the first content, the first message configured to be interpretable by a second routine of a second device and to cause the second device to display the first content;
transmitting, to the second device, the first message;
subsequently, detecting a second update from a second sequence of updates of a second active session of a second application running on the first device;
obtaining, by the first routine, second content based on the second update of the second active session;
generating, by the first routine, a second message using the second content, the second message configured to be interpretable by the second routine and to cause the second device to display the second content; and
transmitting, from the first device to the second device, the second message.

20. The first device of claim 19 further comprising instructions that when executed by one or more processors, cause the device to perform operations including displaying, on the first device, the first update from the first sequence of updates and the second update from the second sequence of updates.
